(19) United States
(12) Patent Application Publication
(10) Pub. No.: US 2010/0199327 A1
(43) Pub. Date: Aug. 5, 2010

(54) METHOD AND APPARATUS FOR SHARING CONTENT IN AN INTERNET BROADCASTING SYSTEM

(75) Inventors: Ji Eun KEUM, Suwon-si (KR); Sung Oh Hwang, Yongin-si (KR); Bo Sun Jung, Seongnam-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/698,592

(22) Filed: Feb. 2, 2010

(30) Foreign Application Priority Data
Feb. 2, 2009 (KR) 10-2009-0008112

(51) Int. Cl. G06F 15/16; G06F 21/00

(52) U.S. Cl. 726/3; 709/217

(57) ABSTRACT

An apparatus and method for sharing content in an Internet broadcasting system that supports broadcasting services using an Internet protocol. The method includes creating, by a bookmark creator, a bookmark for contents, transmitting, by the bookmark creator, the bookmark to a service provider, receiving the bookmark by the service provider, notifying, by the service provider, that the bookmark is updated to a content-sharing party, receiving, by the service provider, a transmission request for the bookmark from the content-sharing party, sending, by the service provider, the bookmark to the content-sharing party, and accessing, by the content-sharing party, the contents by executing the bookmark.

### PRIORITY

This application claims priority under 35 U.S.C. §119(a) to an application filed in the Korean Intellectual Property Office on Feb. 2, 2009 and assigned Serial No. 10-2009-0008112, the content of which is incorporated herein by reference.

### BACKGROUND OF THE INVENTION

1. Field of the Invention

The present invention relates generally to a method and apparatus for sharing content in an internet broadcasting system, and more particularly, to a method for stably sharing content, which is generated within a home network, with certain users of an Internet broadcasting system, and to an apparatus for sharing the content.

2. Description of the Related Art

As a result of Internet Protocol (IP)-based convergence, a fusion of communication and broadcasting is developing as a new next-generation business model, which will likely be one of the leading technologies in the next-generation markets. In particular, an IP television (IPTV) serving as the epitome of the fusion of communication and broadcasting is a system that may provide services in which typical TV, voice and data technologies are combined or recombined, and may support interactivity to create a variety of business models and service as well. These IPTV technologies are used to provide the same services in various environments and are applicable to the various environments by providing the services regardless of the types of terminals and networks. Additionally, it will also be possible to find various types of services, depending on the various environments.

Home network service fused with the IPTV technologies uses IPTV to connect different areas of a house through the Internet and to send and receive information. For example, in a home network, information appliances in a house are connected to a network to configure a “digital home”, which will flexibly provide services without regard to equipment, time, and location.

Generally, in order to share content created within the home network with other users positioned outside the home network, a contents creator uploads the content onto the network and other users download the content, or a contents creator directly transmits the content to certain users via a messaging service, such as electronic mail. However, when the above-mentioned methods are used to share content, a heavy burden may be imposed in loading the content onto the network. Further, the above-mentioned methods potentially expose the content to a security risk.

Accordingly, improved methods for sharing content are required to stably share content from inside a home network with users outside of the home network.

### SUMMARY OF THE INVENTION

The present invention has been made in view of at least the above-described problems, and provides a method for sharing content, wherein a bookmark creator creates a bookmark appoints users who will share content.

In accordance with an aspect of the present invention, a method of sharing content in an Internet broadcasting system that supports broadcasting services using an Internet protocol is provided. The method includes creating, by a bookmark creator, a bookmark for contents; transmitting, by the bookmark creator, the bookmark to a service provider; receiving the bookmark by the service provider; notifying, by the service provider, a content-sharing party that the bookmark is updated; sending the bookmark to the content-sharing party, when the service provider receives a transmission request for the bookmark from the content-sharing party; and accessing, by the content-sharing party, the contents by executing the bookmark.

In accordance with another aspect of the present invention, a method of sharing content in an Internet broadcasting system that supports broadcasting services using Internet protocol is provided. The method includes creating, by a bookmark creator, a bookmark for contents stored with a service provider; notifying, by the service provider, a content-sharing party that the bookmark is updated; sending the bookmark to the content-sharing party, when the service provider receives a transmission request for the bookmark from the content-sharing party; and accessing, by the content-sharing party, the contents by executing the bookmark.

In accordance with another aspect of the present invention, an apparatus for sharing content in an Internet broadcasting system that supports broadcasting services using Internet protocol is provided. The apparatus includes a bookmark creator that creates a bookmark including information on a content identification (ID) and a content-sharing party, transmits the created bookmark to a service provider, and controls access to contents of the content-sharing party; the service provider that receives the bookmark transmitted from the bookmark creator, notifies the content-sharing party that the bookmark is updated, and transmits the bookmark to the content-sharing party, when a transmission request for the bookmark is received from the content-sharing party; and the content-sharing party that requests transmission of the bookmark from the service provider, after being notified that the bookmark is updated, and accesses the contents by executing the bookmark.

In accordance with another aspect of the present invention, a bookmark creator creates a bookmark for contents and transmits the bookmark to a service provider. The service provider authenticates an authorized content-sharing party and provides the authorized content-sharing party with authority to access the contents.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a diagram illustrating domains and value chains related with a conventional IPTV and home network;

FIG. 2 is a diagram illustrating a conventional method for sharing content;

FIG. 3 is a diagram illustrating a Universal Plug and Play Audio Video (UPnP AV) architecture;

FIG. 4 is a diagram illustrating a content-sharing system according to an embodiment of the present invention;

FIG. 5 is a flow chart illustrating a method for sharing content according to an embodiment of the present invention;

FIG. 6 is a flow chart illustrating a method for sharing content according to an embodiment of the present invention; and

FIG. 7 is a flow chart illustrating operations after a service provider receives a bookmark request message from a contents-sharing party, according to an exemplary embodiment of the present invention.

### DETAILED DESCRIPTION OF EMBODIMENTS OF THE INVENTION

Various embodiments of the present invention are described in detail below with reference to the accompanying drawings. In the drawings, the same reference numbers are used throughout to refer to the same or like parts. Further, detailed descriptions of well-known functions and structures incorporated herein may be omitted to avoid obscuring the subject matter of the present invention.

For ease of description of the embodiments of the present invention, the components of the apparatuses according to the present invention have the same names as those defined in Universal Plug and Play (UPnP), which is a home network communication standard, or Open IPTV Forum (OIF), which is an IPTV standards organization. However, it is understood that these standards and names are not intended to limit the scope of the present invention, as the present invention is equally applicable to systems having the similar technical backgrounds.

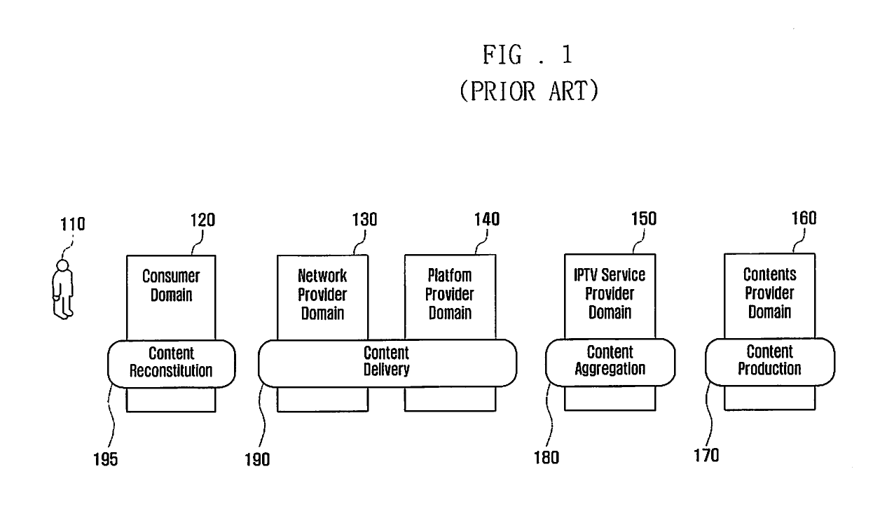

FIG. 1 is a diagram illustrating domains and value chains related with a conventional IPTV and home network.

Referring to FIG. 1, a domain for providing IPTV services to users 110 is basically divisible into five domains including a consumer domain 120, a network provider domain 130, a platform provider domain 140, an IPTV service provider domain 150 and a content provider domain 150.

The consumer domain 120 is a domain that consumes the IPTV services, and may be configured as a terminal for receiving and using the IPTV services and a network (e.g., a home network) including several terminals. For example, the terminal may include a set-top box or a portable terminal that supports a wireless environment such as mobile phone and PDA.

The network provider domain 130 connects the platform provider domain 140 or the service provider domain 150 with the users 110 and sends various types of services and contents to the users 110. The transmission system of the network provider domain 130 may support a variety of transmission technologies such as wired/wireless transmission and broadcasting technologies, and may be generally configured as an access network and a core network.

The platform provider domain 140 is a domain that provides common services to an IPTV service provider, e.g., user authentication and charging.

The IPTV service provider domain 150 is a domain that provides IPTV services to the consumer domain 120, receives content from a content provider, packages the received content for services, and provides the packaged services to the consumer domain 120.

The content provider domain 160 includes content or content assets and generally holds any copyrights on the content or content assets.

In the above-described five domains, it is possible to provide scheduled content services and content on-demand services, as well as a variety of the IPTV services. In this case, these services are provided to combine four major roles to form one value chain.

More specifically, a content production unit 170 is arranged in the content provider domain 160 and produces and edits content.

A content aggregation unit 180 is arranged in an IPTV service provider domain 150 and receives content from a variety of content providers and configures the content into a variety of services.

A content delivery unit 190 is arranged in a platform provider domain 140 and a network provider domain 130 and sends services (i.e., aggregated content), which is provided from the IPTV service providers, to a consumer domain 120.

In addition, a content reconstitution unit 195 is arranged in a consumer domain 120, and converts the received content into a form that is useable by users, and provides the converted content to the users.

In addition, the IPTV services can be divided into a managed model and an unmanaged model (open Internet), depending on whether the Quality of Services (QoS) is provided. In the managed model, a service provider systematically manages the platform provider domain 140, the network provider domain 130, and the IPTV service provider domain 150. Conversely, in the unmanaged model, a service provider and a network provider are separated from each other, and may operate in such a separate manner that the service provider can belong to the IPTV service provider domain 150 to entrust the transmission to other network providers (such as network provider domain 130 and platform provider domain 140).

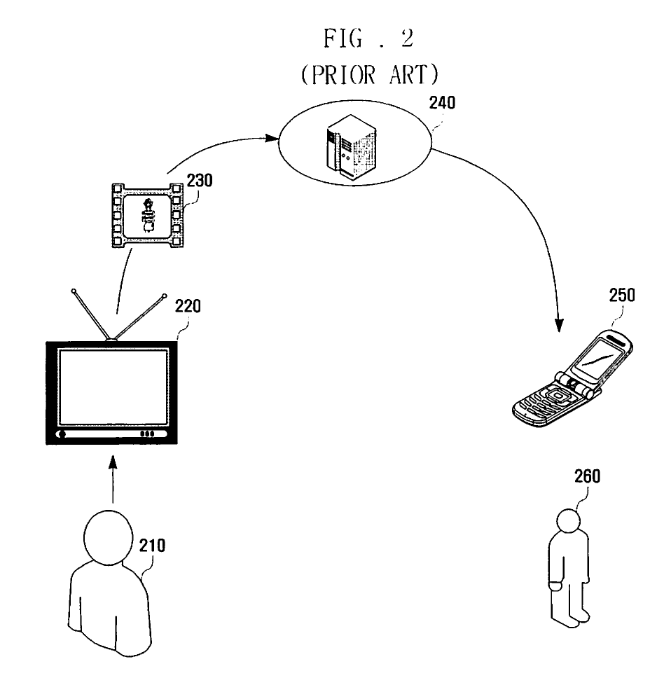

FIG. 2 is a diagram illustrating a conventional method for sharing content.

Referring to FIG. 2, in an existing method, when a content creator 210 desires to share certain contents 230 with other users 260 outside of a home network, the content creator 210 directly transmits the contents 230 via a network 240, or transmits the contents 230 by electronic mail, to devices 250 of the other users 260. However, when such a method is used to share the contents, a heavy content loading burden may be imposed on the network, or the content may be exposed to a security problem.

Accordingly, in order to solve at least the above-mentioned problems, various embodiments of the present invention are provided, which stably share content with certain users by using a bookmark representing the content.

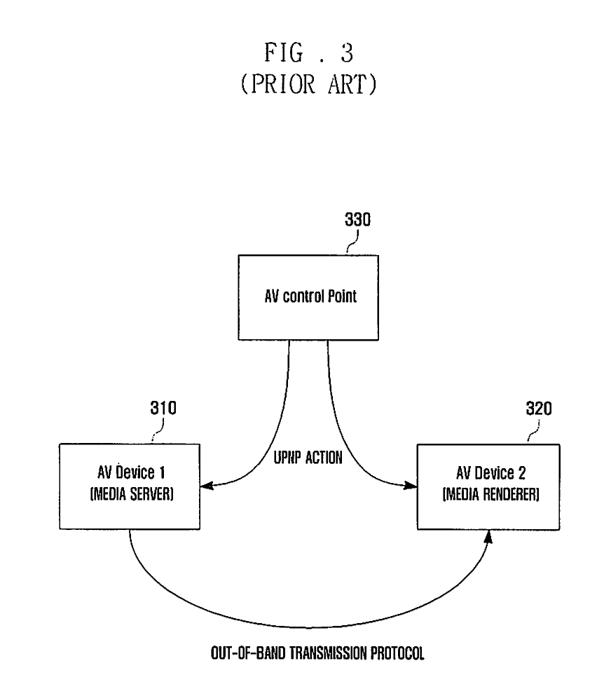

FIG. 3 is a diagram illustrating a configuration of a Universal Plug and Play Audio Video (UPnP AV) architecture.

More specifically, UPnP AV is a universal standard protocol by which network devices of a home network can be associated with each other. UPnP includes a Controlled Device (CD) that is a home network equipment connected to and controlled by an IP-based home network, and a Control Point (CP) for controlling the CD. The CP requests an event and receives the event. The CD executes given functions at the request of the CP. When the state of the CD changes, the CD transmits the event to the CP that requested the event.

For more detail, the UPnP AV technology, which can be used to enjoy multimedia content, such as audio/video content, based on the above-mentioned UPnP, is described in the UPnP AV Specification.

Referring to FIG. 3, according to the UPnP AV standard regulations, an AV device 1 310 is a media server including AV content. Specifically, the AV device 1 310 stores a variety of image files or audio/video files through a Content Directory Service (CDS).

The CDS is a service installed inside the media server 310, and provides metadata of contents, which exist inside and/or outside the home network or are stored in the media server 310, to AV CP 330. Examples of the media server include a personal computer (including, for example, optical devices such as a Hard Disk Drive (HDD), flash memories, a Digital Video Disc/Compact Disc (DVD/CD), a set-top box, a DVD player, a Moving Picture Experts Group Layer-3 Audio (MP3) player, and a Digital Still Camera (DSC)) or the like. An AV device 2 320 is a media rendering device with which a user can use AV content. Examples of the AV device 2 320 include a Digital TV (DTV), a High Fidelity (HiFi) audio receiver, and a monitor. The AV device 2 320 receives the AV contents from the AV device 1 310 through an out-of-band transmission protocol. A bookmark representing a specific time point of contents created in a home network is defined on UPnP, which is used on the home network. The bookmark is created by using the UPnP CDS service.

An embodiment of a bookmark (underlined) represented by using UPnP is illustrated in Table 1 below.

TABLE 1

<?xml version=“1.0” encoding=“UTF-8”?>
<DIDL-Lite
xmlns:dc=“http://purl.org/dc/elements/1.1/”
xmlns=“urn:schemas-upnp-org:metadata-1-0/DIDL-Lite/”
xmlns:upnp=“urn:schemas-upnp-org:metadata-1-0/upnp/”
xmlns:xsi=“http://www.w3.org/2001/XMLSchema-instance”
xsi:schemaLocation=“
urn:schemas-upnp-org:metadata-1-0/DIDL-Lite/
http://www.upnp.org/schemas/av/didl-lite.xsd
urn:schemas-upnp-org:metadata-1-0/upnp/
http://www.upnp.org/schemas/av/upnp.xsd”>
<item id=“bookmark-763215” parentID=“BC_001”
restricted=“0”>
<dc:title>Gone with the Wind</dc:title>
<upnp:class>object.item.bookmarkItem</upnp:class>
<upnp:deviceUDN serviceType=“AVTransport:1”
serviceId=“AVTransport”>
uuid:2F5A2466-55EF-44af-953A-74DE96FF2B14
</upnp:deviceUDN>
<upnp:deviceUDN serviceType=“RenderingControl:1”
serviceId=“RenderingControl”>
uuid:EF0DB408-3018-4e13-831A-8349CA543538
</upnp:deviceUDN>
<upnp:bookmarkedObjectID>1230131</upnp:bookmarkedObjectID>
<dc:date>2003-03-21T15:21:22</dc:date>
<upnp:stateVariableCollection serviceName=“AVTransport”>
<!--
The following stateVariableValuePairs XML Document needs to be

interpreted as a simple string and therefore needs to be properly escaped

-->
&lt;?xml version=“1.0” encoding=“UTF-8”?&gt;
&lt;stateVariableValuePairs
xmlns=“urn:schemas-upnp-org:av:avs”
xmlns:xsi=“http://www.w3.org/2001/XMLSchema-instance”
xsi:schemaLocation=“
urn:schemas-upnp-org:av:avs
http://www.upnp.org/schemas/av/avs.xsd”&gt;
&lt;stateVariable variableName=“RelativeTimePosition”&gt;
00:22:01
&lt;stateVariable&gt;
&lt;!-- More state variable value pairs can
be inserted here --&gt;
&lt;/stateVariableValuePairs&gt;
<!-- End of stateVariableValuePairs XML Document -->
</item

In order to safely share the contents, the present invention provides a method for sending authority for accessing contents to other users by using the UPnP bookmark format, without directly loading or transmitting the contents.

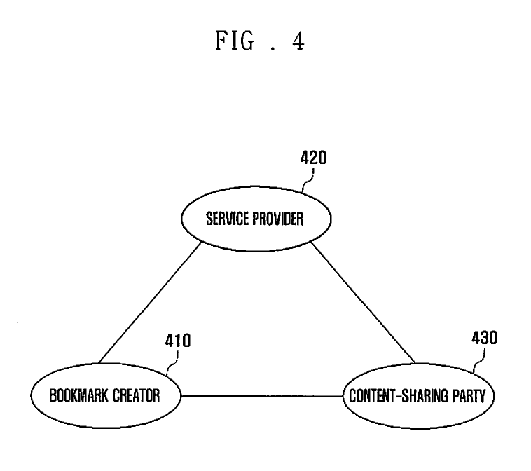

FIG. 4 is a diagram a content-sharing system according to an embodiment of the present invention.

Referring to FIG. 4, the content-sharing system includes a bookmark creator 410, a service provider 420 and a content-sharing party 430.

The bookmark creator 410 is, for example, an IPTV service subscriber, which creates content through a home network device or plays created content. For instance, the bookmark creator 410 directly creates and stores content using the home network device such as a camcorder, and then may play the stored contents. In addition, the bookmark creator 410 may create a bookmark for sharing the created contents with a designated sharing party, and transmit the created bookmark to a service provider 420.

According to another embodiment of the present invention, the bookmark creator 410 may directly create contents, without the use of a home network device, and create a bookmark for the created contents. Further, the bookmark creator 410 may play contents stored in the service provider 420 and create a bookmark for the contents stored in the service provider 420. In this case, metadata of the bookmark for providing information on a location of the contents is illustrated in Table 2 below.

TABLE 2

| Metadata | Description |
|---|---|
| ContLoc@type | 1: Contents are arranged in a |
| (Content Location/Type) | service provider. |
| | 2: Contents are arranged in the |
| | inside of a home of a bookmark creator. |
| ContLoc@URI | If “Content Location” type = 1, it. |
| (Content | indicates a content server address of |
| Location/Address) | the service provider network. |
| | If “Content Location” type = 2, it |
| | indicates the inside of a home of a |
| | bookmark creator. |

Referring to Table 2, a value of ‘ContLoc@type’ being 1, indicates that the contents are arranged in a content server of the service provider 420. A value of ‘ContLoc@type’ being 2, indicates that the contents are arranged inside of a home of the bookmark creator 410.

In addition, ‘ContLoc@URI’ represents an address, i.e., Uniform Resource Identifier (URI), of a server in which the contents are located. Here, a value of ‘ContLoc@URI’ being 1, indicates an address of a content server of the service provider 420. Conversely, a value of ‘ContLoc@URI’ being 2, indicates an address of a content storage in the home of the bookmark creator 410.

In accordance with an embodiment of the present invention, the bookmark creator creates a bookmark including at least one of a storage location and a storage address of contents as listed in Table 2.

Referring back to FIG. 4, the bookmark creator 410 receives device ID and cryptogram information of the content-sharing party 430 transmitted from the service provider 420, and controls access of the content-sharing party 430 to the contents.

The service provider 420 is, for example, an IPTV service provider that provides IPTV services. The service provider 420 receives the bookmark transmitted from the bookmark creator 410, buffers the received bookmark, and notifies the content-sharing party 430 that the bookmark is updated. When the service provider 420 receives a bookmark request from the content-sharing party 430, the service provider 420 authenticates the content-sharing party 430 by determining whether the content-sharing party 430 is an authorized user, i.e., a user having the sharing authority. After the authentication, the service provider 420 transmits to the content-sharing party 430 the buffered bookmark and the cryptogram information required for the access to the contents. At the same time, the service provider 420 transmits to the bookmark creator 410 the device ID of the content-sharing party and the cryptogram information required to control the access to the contents. In this case, the cryptogram information transmitted to the bookmark creator 410 is identical to the cryptogram information transmitted to the content-sharing party 430.

In accordance with another embodiment of the present invention, the service provider 420 includes a content server for storing content. The content-sharing party 430, e.g., an IPTV service subscriber, shares contents with the bookmark creator 410. The content-sharing party 430 requests an updated bookmark when the content-sharing party 430 receives the bookmark update notification from the service provider 420. The content-sharing party 430 may receive the bookmark and cryptogram information from the service provider 420 to access to the contents of the bookmark creator 410.

According to an embodiment of the present invention, the bookmark creator 410 and the content-sharing party 430 may include Digital Living Network Alliance (DLNA) functions.

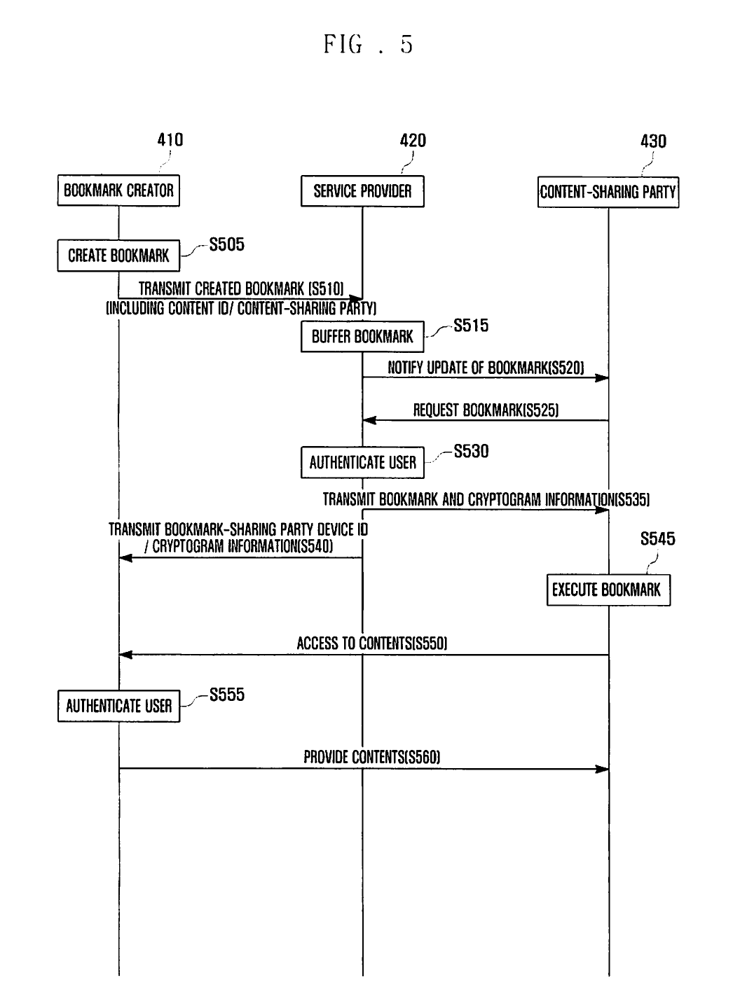

FIG. 5 is a flow chart illustrating a method for sharing content according to an embodiment of the present invention. More specifically, FIG. 5 illustrates an embodiment in which contents that users want to share are arranged inside a home network of a bookmark creator 410.

Referring to FIG. 5, the bookmark creator 410 creates a bookmark for contents, when the bookmark creator 410 desires to share the contents with users outside of the home network in step S505. Here, the bookmark includes information on a content-sharing party 430 that wants to share the contents and information on a contents ID for sharing. An example of a bookmark in accordance with an embodiment of the present invention is shown below in Table 3.

TABLE 3

<?xml version=“1.0” encoding=“UTF-8”?>
<DIDL-Lite
xmlns:dc=“http://purl.org/dc/elements/1.1/”
xmlns=“urn:schemas-upnp-org:metadata-1-0/DIDL-Lite/”
xmlns:upnp=“urn:schemas-upnp-org:metadata-1-0/upnp/”
xmlns:xsi=“http://www.w3.org/2001/XMLSchema-instance”
xsi:schemaLocation=“
urn:schemas-upnp-org:metadata-1-0/DIDL-Lite/
http://www.upnp.org/schemas/av/didl-lite.xsd
urn:schemas-upnp-org:metadata-1-0/upnp/
http://www.upnp.org/schemas/av/upnp.xsd”>
<item id=“bookmark-763215” parentID=“BC_001”
restricted=“0”>
<upnp:deviceUDN serviceType=“AVTransport:1”
serviceId=“AVTransport”>
uuid:2F5A2466-55EF-44af-953A-74DE96FF2B14
</upnp:deviceUDN>
<upnp:deviceUDN serviceType=“RenderingControl:1”
serviceId=“RenderingControl”>
uuid:EF0DB408-3018-4e13-831A-8349CA543538
</upnp:deviceUDN>
<upnp:share creatorid=“JiEun” type=“limited public”

shareuserid=“Bosun,Sungoh”></share>

<upnp:ContentsLoctype=“2” RI=sktuser/Jieun/></ContentsLoc>
<upnp:bookmarkedObjectID>1230131</upnp:bookmarkedObjectID>
<dc:date>2003-03-21T15:21:22</dc:date>
<upnp:stateVariableCollection serviceName=“AVTransport”>
<!--
The following stateVariableValuePairs XML Document needs to be

interpreted as a simple string and therefore needs to be properly escaped

-->
&lt;?xml version=“1.0” encoding=“UTF-8”?&gt;
&lt;stateVariableValuePairs
xmlns=“urn:schemas-upnp-org:av:avs”
xmlns:xsi=“http://www.w3.org/2001/XMLSchema-instance”
xsi:schemaLocation=“
urn:schemas-upnp-org:av:avs
http://www.upnp.org/schemas/av/avs.xsd”&gt;
&lt;stateVariable variableName=“RelativeTimePosition”&gt;
00:22:01
&lt;stateVariable&gt;
&lt;!-- More state variable value pairs can
be inserted here --&gt;
&lt;/stateVariableValuePairs&gt

Referring to the bookmark in Table 3, as indicated in bold text, the bookmark creator 410 wants to share the contents with ‘Bosun or Sungoh’ (‘shareuserid=“Bosun,Sungoh”’), the contents are arranged inside the home network of the bookmark creator 410 (‘ContentsLoc type=“2”’), and the address of bookmark creator 410 is ‘sktuser/Jieun’ (‘URI=sktuser/Jieun’).

In step S510, the bookmark creator 410 transmits the created bookmark to the service provider 420. The service provider 420 buffers the bookmark transmitted from the bookmark creator 410 in step S515. In step S520, the service provider 420 checks the content-sharing party 430 included in the bookmark, and notifies the content-sharing party 430 that the bookmark is updated.

After the content-sharing party 430 receives the bookmark update notification from the service provider 420, the content-sharing party 430 transmits a bookmark request message, requesting the updated bookmark from the service provider 420 in step S525.

Here, the bookmark request message includes the device ID that the content-sharing party 430 uses.

In step S530, the service provider 420 receiving the bookmark request message authenticates the content-sharing party 430 by determining whether the content-sharing party 430 has sharing authority. For example, the service provider 420 may check whether the content-sharing party 430 has the sharing authority by comparing the device ID of the content-sharing party 430 included in the bookmark request message with the information on the content-sharing party included in the bookmark.

When the authentication is completed, the service provider 420 transmits the bookmark and cryptogram information to the content-sharing party 430 in step S535. Here, the cryptogram information is used for the bookmark creator 410 to authenticate the sharing authority of the content-sharing party 430 for access to the contents indicated by the bookmark. In step S540, the service provider 420 transmits the device ID and cryptogram information of the content-sharing party 430 to the bookmark creator 410.

According to an embodiment of the present invention, the cryptogram information transmitted to the content-sharing party 430 by the service provider 420 at step 535 can be identical with the cryptogram information transmitted to the bookmark creator 410 by the service provider 420 at step 540.

In step S545, the content-sharing party 430 executes the received bookmark, and in step S550, the content-sharing party 430 transmits a content access message to a home server address of the bookmark creator 410 in which the contents are stored. In accordance with an embodiment of the present invention, the content access message includes the cryptogram information received at step 535.

In step S555, the bookmark creator 410, after receiving the content access message, executes an authentication process by comparing the cryptogram information received from the service provider 420 with the cryptogram information included in the content access message. When the authentication is admitted, the bookmark creator 410 permits the access by content-sharing party 430 to the contents and provides the contents to the content-sharing party 430 in step S560.

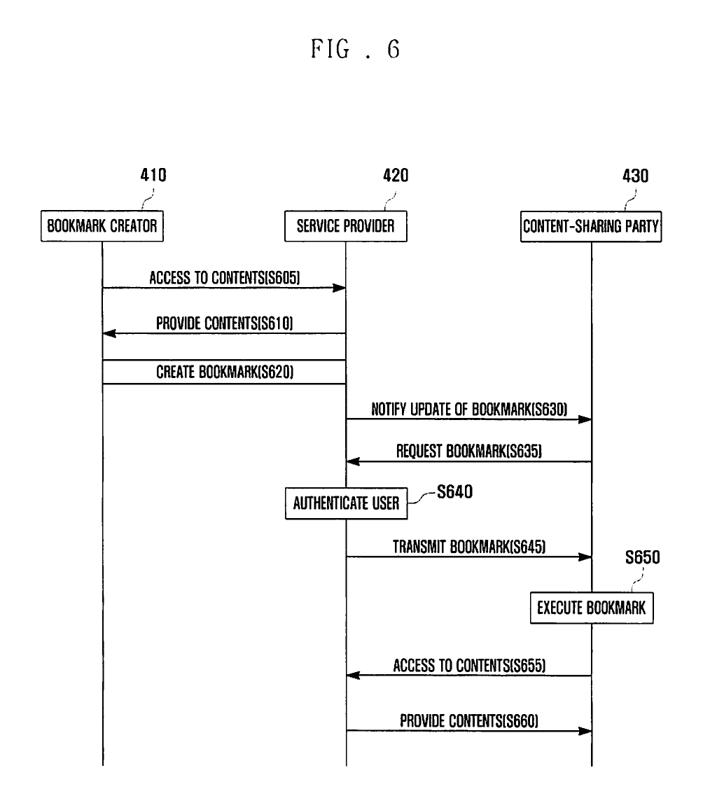

FIG. 6 is a flow chart illustrating a method for sharing content according to another embodiment of the present invention. More specifically, FIG. 6 illustrates an embodiment different from the embodiment illustrated in FIG. 5 in that the contents are stored in a service provider, not the bookmark creator.

Referring to FIG. 6, a bookmark creator 410 requests access to contents stored in a service provider 420 in step S605. In step S610, the service provider 420 permits the bookmark creator 410 to gain access to the contents and provides the contents to the bookmark creator 410. In step S620, the bookmark creator 410 creates a bookmark in Service Provider 420 for the contents for sharing the contents with other users. Here, the bookmark includes information on the content-sharing party 430 and a content ID.

An example of a bookmark in accordance with an embodiment of the present invention is shown in Table 4 below.

TABLE 4

<?xml version=“1.0” encoding=“UTF-8”?>
<DIDL-Lite
xmlns:dc=“http://purl.org/dc/elements/1.1/”
xmlns=“urn:schemas-upnp-org:metadata-1-0/DIDL-Lite/”
xmlns:upnp=“urn:schemas-upnp-org:metadata-1-0/upnp/”
xmlns:xsi=“http://www.w3.org/2001/XMLSchema-instance”
xsi:schemaLocation=“
urn:schemas-upnp-org:metadata-1-0/DIDL-Lite/
http://www.upnp.org/schemas/av/didl-lite.xsd
urn:schemas-upnp-org:metadata-1-0/upnp/
http://www.upnp.org/schemas/av/upnp.xsd”>
<item id=“bookmark-763215” parentID=“BC_001”
restricted=“0”>
<upnp:class>object.item.bookmarkItem</upnp:class>
<upnp:deviceUDN serviceType=“AVTransport:1”
serviceId=“AVTransport”>
uuid:2F5A2466-55EF-44af-953A-74DE96FF2B14
</upnp:deviceUDN>
<upnp:deviceUDN serviceType=“RenderingControl:1”
serviceId=“RenderingControl”>
uuid:EF0DB408-3018-4e13-831A-8349CA543538
</upnp:deviceUDN>
<upnp:share creatorid=“JiEun” type=“limited public”

shareuserid=“Bosun,Sungoh”></share>

<upnp:ContentsLoctype=“1”URI=SKtelecom/contentserver/server1/

></ContentsLoc>

<upnp:bookmarkedObjectID>1230131</upnp:bookmarkedObjectID>
<dc:date>2003-03-21T15:21:22</dc:date>
<upnp:stateVariableCollection serviceName=“AVTransport”>
<!--
The following stateVariableValuePairs XML Document needs to be

interpreted as a simple string and therefore needs to be properly escaped

-->
&lt;?xml version=“1.0” encoding=“UTF-8”?&gt;
&lt;stateVariableValuePairs
xmlns=“urn:schemas-upnp-org:av:avs”
xmlns:xsi=“http://www.w3.org/2001/XMLSchema-instance”
xsi:schemaLocation=“
urn:schemas-upnp-org:av:avs
http://www.upnp.org/schemas/av/avs.xsd”&gt;
&lt;stateVariablevariableName=“RelativeTimePosition”&gt;
00:22:01
&lt;stateVariable&gt;
&lt;!-- More state variable value pairs can
be inserted here --&gt;
&lt;/stateVariableValuePairs&gt;

Referring to the bookmark listed in Table 4, as indicated in bold text, the bookmark creator 410 wants to share the contents with ‘Bosun or Sungoh’ (‘shareuserid=“Bosun,Sungoh”’), the contents are arranged in the content server of the service provider 420 (‘ContentsLoc type=“1”’), and the address is ‘SKtelecom’ (‘URI=SKtelecom/contentserver/server1’).

In step S630, the service provider 420 checks the information on the content-sharing parties 430 included in the created bookmark, and notifies the content-sharing party 430 that the bookmark is updated.

After the content-sharing party 430 receives the bookmark update notification from the service provider 420, the content-sharing party 430 transmits a bookmark request message to the service provider 420 in step S635, requesting the updated bookmark. Here, the bookmark request message includes the ID of device used by the content-sharing party 430.

In step S640, the service provider 420, after receiving the bookmark request message, authenticates the content-sharing party 430 by determining whether the content-sharing party 430 has sharing authority. Also, the service provider 420 can authenticate access authority to the contents of the content-sharing party 430. For example, the service provider 420 may authenticate by comparing the device ID of the content-sharing party 430 included in the bookmark request message with information on content-sharing parties included in the bookmark. Accordingly, the service provider 420 can authenticate both sharing authority and access authority in step S640.

After the authentication is completed, the service provider 420 transmits the bookmark to the content-sharing party 430 in step S645.

In step S650, the content-sharing party 430 executes the received bookmark, and in step S655, the content-sharing party 430 transmits a content access message to a home server address of the service provider 420 in which the contents are stored. In this case, because the content-sharing party 430 has already been authenticated at step S640, the service provider 420 permits the content-sharing party 430 to gain access to the contents without executing an additional authentication process, and provides the contents to the content-sharing party 430 in step S660.

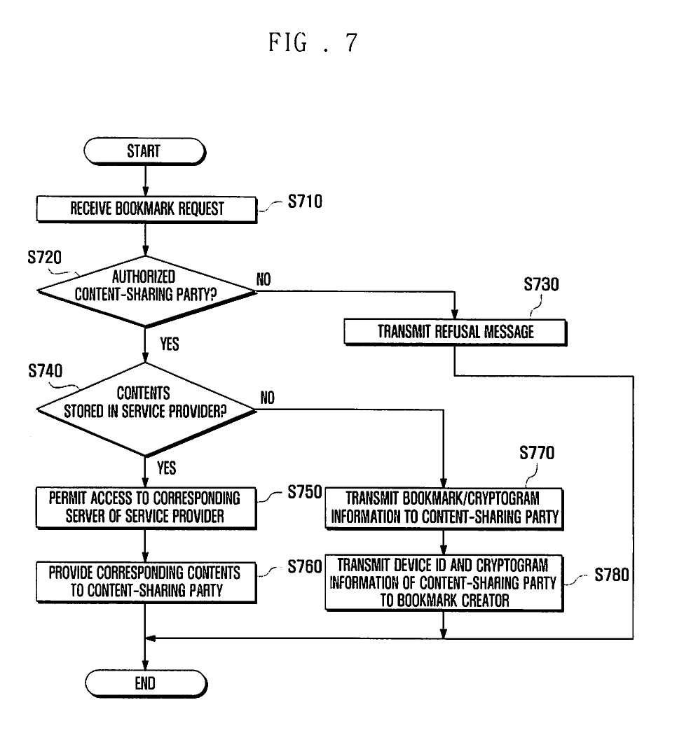

FIG. 7 is a flow chart illustrating operations after a service provider receives a bookmark request message from a content-sharing party, according to an exemplary embodiment of the present invention.

Referring to FIG. 7, a service provider 420 receives a bookmark request message from a content-sharing party 430 in step S710. In step S720, the service provider 420 determines whether the content-sharing party 430 requesting the bookmark has sharing authority. For example, the service provider 420 may determine whether the content-sharing party 430 has the sharing authority by checking if the content-sharing party 430 matches a sharing party indicated in the bookmark.

When the bookmark sharing party 430 does not have sharing authority, the service provider 420 transmits a refusal message to the bookmark sharing party 430 in step S730.

However, when the content-sharing party 430 has sharing authority, the service provider 420 determines whether the contents for sharing are stored in the content server of the service provider in step S740. For example, the service provider 420 may locate a storage of the contents using metadata of the bookmark, as shown in Table 2.

When the contents are stored in the service provider, the service provider 420 permits access by the content-sharing party 430 to a corresponding content server in step S750. In step S760, the service provider 420 provides the contents to the content-sharing party 430.

However, when the contents are not stored in the service provider, e.g., the contents are stored inside of a home of the bookmark creator 410, the service provider 420 transmits the bookmark and cryptogram information to the content-sharing party 430 in step S770. Further, the service provider 430 transmits the device ID and cryptogram information of the content-sharing party to the bookmark creator 410 in step S780.

As described above, the present invention reduces a risk of exposing content during content sharing and reduces a load of a network as only a bookmark is used to share content, without directly uploading or transmitting contents for sharing.

Although certain embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of sharing content in an Internet broadcasting system that supports broadcasting services using an Internet protocol, the method comprising:
creating, by a bookmark creator, a bookmark for contents;
transmitting, by the bookmark creator, the bookmark to a service provider;
receiving the bookmark by the service provider;
notifying, by the service provider, that the bookmark is updated to a content-sharing party;
receiving, by the service provider, a transmission request for the bookmark from the content-sharing party;
sending, by the service provider, the bookmark to the content-sharing party; and
accessing, by the content-sharing party, the contents by executing the bookmark.

2. The method of claim 1, wherein the bookmark includes information on a content Identification (ID) and the content-sharing party.

3. The method of claim 1, wherein the bookmark includes at least one of a storage location and a storage address of the contents.

4. The method of claim 1, further comprising:
authenticating, by the service provider, sharing authority of the content-sharing party requesting the bookmark, before the sending of the bookmark.

5. The method of claim 1, further comprising:
sending, by the service provider, cryptogram information for authenticating access to the contents with the bookmark to the content-sharing party.

6. The method of claim 5, further comprising:
transmitting, by the service provider, the cryptogram information to the bookmark creator.

7. The method of claim 6, further comprising:
authenticating, by the bookmark creator, access authority of the content-sharing party through using the cryptogram information, when the content-sharing party attempts to access to the contents.

8. The method of claim 1, wherein the contents are located within a home network of the bookmark creator.

9. A method of sharing content in an Internet broadcasting system that supports broadcasting services using an Internet protocol, the method comprising:
creating, by a bookmark creator, a bookmark for contents located in a service provider;
notifying, by the service provider, that the bookmark is updated to a content-sharing party;
receiving, by the service provider, a transmission request for the bookmark from the content-sharing party;
sending, by the service provider, the bookmark to the content-sharing party; and
accessing, by the content-sharing party, the contents by executing the bookmark.

10. The method of claim 9, wherein the bookmark includes information on a content Identification (ID) and the content-sharing party.

11. The method of claim 9, wherein the bookmark includes at least one of a storage location and a storage address of the contents.

12. The method of claim 9, further comprising:
authenticating, by the service provider, sharing authority of the content-sharing party requesting the bookmark, before sending the bookmark.

13. The method of claim 12, wherein authenticating the sharing authority of the content-sharing party comprises:
authenticating, by the service provider, access authority to the contents for the content sharing party.

14. An apparatus for sharing content in an Internet broadcasting system that supports broadcasting services using an Internet protocol, the apparatus comprising:
a bookmark creator that creates a bookmark including information for identifying contents and a content-sharing party, transmits the bookmark to a service provider, and controls access to the contents;
the service provider that receives the bookmark from the bookmark creator, notifies the content-sharing party that the bookmark is updated, receives a transmission request for the bookmark from the content-sharing party, and transmits the bookmark to the content-sharing party; and
the content-sharing party that transmits the transmission request for the bookmark to the service provider, after being notified that the bookmark is updated, receives the bookmark from the service provider, and accesses the contents by executing the bookmark.

15. The apparatus of claim 14, wherein the service provider authenticates sharing authority of the content-sharing party that requests the transmission of the bookmark.

16. The apparatus of claim 14, wherein the service provider transmits cryptogram information with the bookmark to the content-sharing party and the bookmark creator, the cryptogram information being used to authenticate access to the contents.

17. The apparatus of claim 16, wherein the bookmark creator authenticates sharing authority of the content-sharing party by using the cryptogram information, when the content-sharing party attempts to access the contents.

18. The apparatus of claim 14, wherein the bookmark further comprises at least one of information on a storage location of the contents and information on a storage address of the contents.
